(19) United States
(12) Patent Application Publication
(10) Pub. No.: US 2014/0115356 A1
(43) Pub. Date: Apr. 24, 2014

(54) TRANSFORMER CAPABLE OF AUTOMATIC INPUT POWER ADJUSTMENT AND COMPUTER USING THE TRANSFORMER

(71) Applicants: INVENTEC (PUDONG) TECHNOLOGY CORPORATION, Shanghai (CN); INVENTEC CORPORATION, Taipei (TW)

(72) Inventor: Chiung-Liang Chiu, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/783,567

(22) Filed: Mar. 4, 2013

(30) Foreign Application Priority Data
Oct. 23, 2012 (CN) 201210406268.6

(51) Int. Cl. G06F 1/32

(52) U.S. Cl. CPC G06F 1/3234
USPC 713/320

(57) ABSTRACT

A transformer and a computer capable of automatic input power adjustment are provided, and the computer includes an electronic apparatus and a transformer. The electronic apparatus has a power source module and a wake-up module. The transformer has a switch module, a power supply module and a detection module. The power supply module is connected to the switch module and the detection module. The switch module transmits external power to the power supply module. The power supply module transforms the external power to operation power, and transmits the operation power to a power source module. When the operation power is lower than a charge threshold, the detection module commands the switch module to stop receiving the external power.

### CROSS-REFERENCE TO RELATED APPLICATIONS

This non-provisional application claims priority under 35U.S.C. §119(a) on Patent Application No(s). 201210406268.6 filed in China on Oct. 23, 2012, the entire contents of which are hereby incorporated by reference.

### BACKGROUND OF THE INVENTION

1. Technical Field of the Invention

The disclosure relates to a transformer and a computer, and more particularly to a transformer capable of automatic input power adjustment and a computer with the transformer.

2. Description of the Related Art

With the popularization of computers, many people must rely on computer to complete work. For the ability to move easily and give a presentation easily, some users work with mobile computers, such as notebooks or tablets.

However, these mobile computers receive operation power for its operation from batteries or external power. Generally, a transformer is used for transforming the external power to the operation power of the mobile computer. Meanwhile, the operation power output by the transformer can also be used to charge the battery.

When the mobile computer enters a sleep mode or the battery thereof is fully charged, the transformer continuously transforms the external power to operation power, which not only wastes power, but also raises the temperature of the battery or the transformer. The rise of the temperature affects the service life of the mobile computer or the transformer.

### SUMMARY OF THE INVENTION

A transformer capable of automatic input power adjustment disclosed in the present disclosure has a switch module, a power supply module and a detection module. The power supply module is connected to the switch module and the detection module. The switch module transmits external power to the power supply module. The power supply module transforms the external power to operation power, and transmits the operation power to a power source module. When the operation power is lower than a charge threshold, the detection module commands the switch module to stop receiving the external power.

The disclosure further provides a computer capable of automatic input power adjustment, which comprises an electronic apparatus and a transformer. The electronic apparatus has a power source module and a wake-up module. The transformer has a switch module, a power supply module and a detection module. The power supply module is connected to the switch module and the detection module. The switch module transmits external power to the power supply module. The power supply module transforms the external power to operation power, and transmits the operation power to a power source module. When the operation power is lower than a charge threshold, the detection module commands the switch module to stop receiving the external power.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic architectural view of the disclosure;

FIG. 2 is a schematic view of an operation process of the disclosure; and

FIG. 3 is a schematic architectural view of another implementation manner of the disclosure.

### DETAILED DESCRIPTION

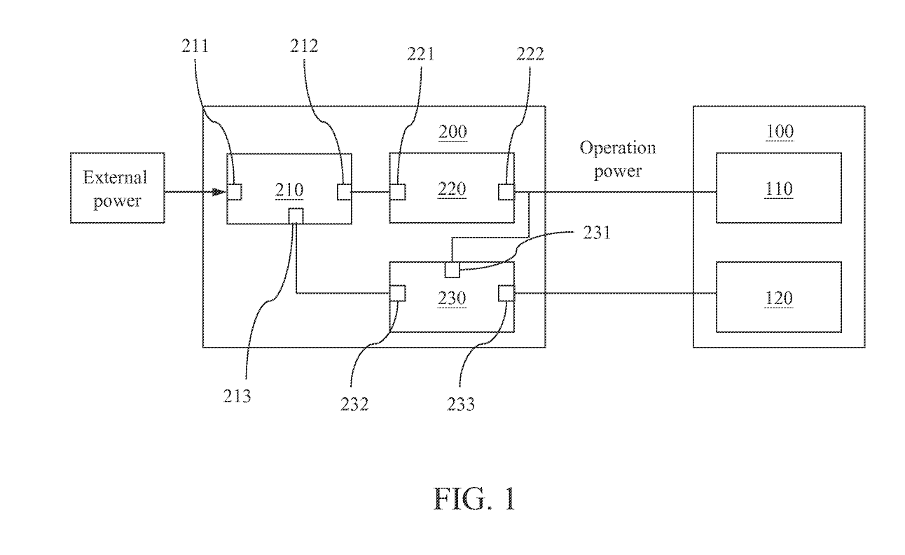

A computer capable of automatic input power adjustment comprises an electronic apparatus and a transformer. Referring to FIG. 1, it is a schematic view of the disclosure. In this embodiment and some embodiments, an electronic apparatus 100 is, but not limited to, a personal computer, a notebook, a tablet or a cellphone. The electronic apparatus 100 comprises a power source module 110 and a wake-up module 120. In this embodiment and some embodiments, the power source module 110 is an external battery of the electronic apparatus 100, or a built-in power supply unit of the electronic apparatus 100. In this embodiment and some embodiments, the wake-up module 120 is an independent hardware, or is built in a Southbridge Chip.

The transformer 200 comprises a switch module 210, a power supply module 220 and a detection module 230. The switch module 210 at least comprises three connection ends. A first connection end 211 of the switch module 210 is capable of receiving external power, a second connection end 212 is electrically connected to the power supply module 220, and a third connection end 213 is electrically connected to the detection module 230. The switch module 210 is capable of deciding whether to receive external power according to different external signals. Specifically, the switch module 210 has two different operation states, namely, on-state and off-state. In the on-state, the external power is transmitted to the power supply module 220. When being switched to the off-state, the switch module 210 interrupts the external power to the electronic apparatus 100, so that the transformer 200 does not transmit and transform the external power. In this embodiment and some embodiments, the interruption is performed by a selector switch entity or a control chip.

An input end 221 of the power supply module 220 is connected to the second connection end 212 of the switch module 210 to receive the external power. The power supply module 220 transforms the external power to operation power for the operation of the electronic apparatus 100. The power supply module 220 supplies the operation power to the electronic apparatus 100 through a shared end 222. A first end 231 of the detection module 230 is connected to the power supply module 220, a second end 232 is connected to the third connection end 213 of the switch module 210, and a third end 233 is connected to the wake-up module 120 of the electronic apparatus 100. The detection module 230 is used for detecting the operation power that flows to the power source module 110.

When it is detected by the detection module 230 that the operation power is higher than or equal to a charge threshold, the detection module 230 does not send any switching signal to the switch module 210. When it is detected by the detection module 230 that the operation power is lower than the charge threshold, the detection module 230 sends an interruption request to the switch module 210. Upon receiving the interruption request, the switch module 210 stops supplying external power to the power supply module 220. Generally speaking, charge efficiency of the power source module 110 is inversely proportional to the electric quantity of, for example, the external battery. As the electric quantity of the power source module 110 approaches to saturation level, the operation power capable of being input in the power source module decreases accordingly. Therefore, the detection module 230 is capable of determining the electric quantity of the power source module 110 according to the change of the operation power.

If the electric quantity of the power source module 110 is lower than a working threshold, the wake-up module 120 sends a wake-up command to the detection module 230, so that the detection module 230 drives the switch module 210 to transmit the external power to the power supply module 220 again. The power supply module 220 transforms the external power to the operation power and transmits the operation power to the power source module 110.

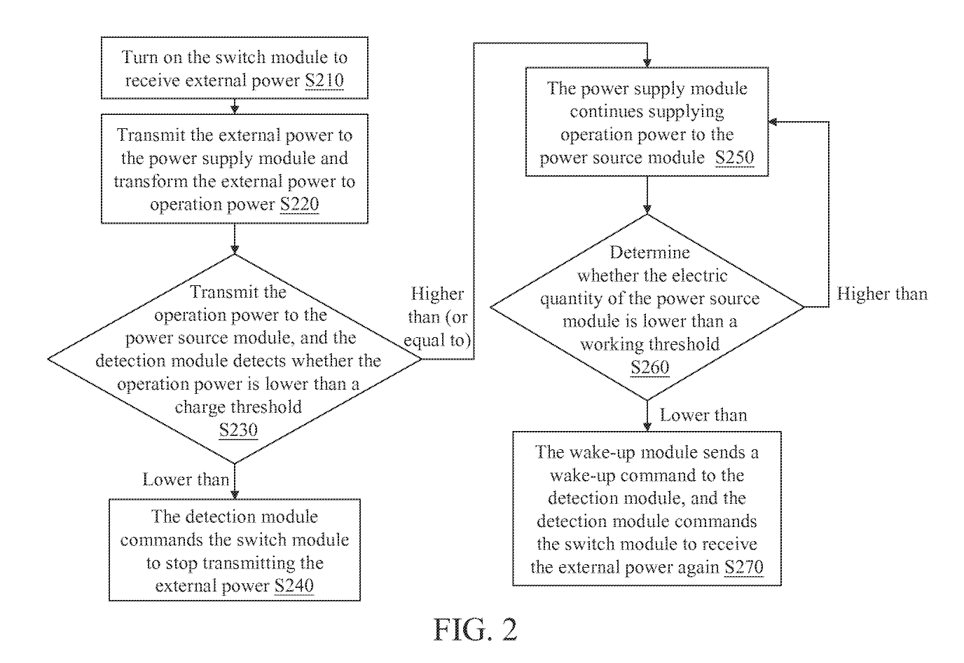

To illustrate the operation process of the disclosure clearly, FIG. 2 shows a flow chart of the operation processes. The automatic input power adjustment of the disclosure comprises the following steps:

In Step S210, the switch module is turned on and receives external power.

In Step S220, the external power is transmitted to the power supply module and is transformed to operation power.

In Step S230, the operation power is transmitted to the power source module, and the detection module detects whether the operation power is lower than a charge threshold.

In Step S240, if the operation power is lower than the charge threshold, the detection module commands the switch module to stop transmitting the external power.

In Step S250, if the operation power is higher than (or equal to) the charge threshold, the power supply module continues supplying operation power to the power source module.

In Step S260, it is determined whether the electric quantity of the power source module is lower than a working threshold; if the electric quantity is higher than the working threshold, the processes go back to Step S250.

In Step S270, if the electric quantity of the power source module is lower than the working threshold, the wake-up module sends a wake-up command to the detection module, and the detection module commands the switch module to receive the external power again.

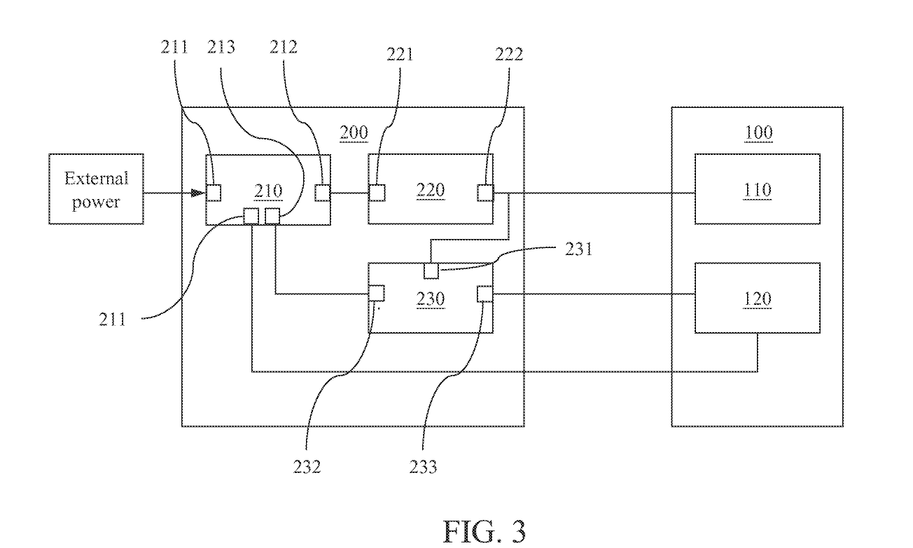

In addition to the above embodiment, the disclosure provides another embodiment. Referring to FIG. 3, it is a schematic view of another embodiment of the disclosure. A computer comprises an electronic apparatus 100 and a transformer 200. The electronic apparatus 100 comprises a power source module 110 and a wake-up module 120.

The transformer 200 comprises a switch module 210, a power supply module 220 and a detection module 230. A first connection end 211 of the switch module 210 is capable of receiving external power, a second connection end 212 is connected to the power supply module 220, and a third connection end 213 is connected to the detection module 230. An input end 221 of the power supply module 220 is connected to a second end 232 of the switch module 210 to receive the external power. The power supply module 220 transforms the external power to operation power. The power supply module 220 supplies the operation power to the electronic apparatus 100 through a shared end 222. A first end 231 of the detection module 230 is connected to the power supply module 220, the second connection end 232 is connected to the third end 213 of the switch module 210, and a third end 233 is connected to the wake-up module 120 of the electronic apparatus 100. The detection module 230 is used for detecting the operation power that flows to the power source module 110.

When the operation power detected by the detection module 230 is higher than or equal to a charge threshold, the detection module 230 does not send any switching signal to the switch module 210. When the operation power detected by the detection module 230 is lower than the charge threshold, the detection module 230 sends an interruption request to the switch module 210. Upon receiving the interruption request, the switch module 210 stops supplying external power to the power supply module 220.

If the electric quantity of the power source module 110 is lower than a working threshold, the wake-up module 120 sends a wake-up command to the switch module 210, so that the switch module 210 transmits the external power to the power supply module 220 again. The power supply module 220 transforms the external power to the operation power and transmits the operation power to the power source module 110.

The transformer 200 capable of automatic input power adjustment and computer with the transformer 200 according to the disclosure is capable of determining whether the battery is fully charged during operation of the computer. If the battery is fully charged, the transformer 200 is capable of temporarily interrupting input of the operation power, so as to protect the battery of the computer.

What is claimed is:

1. A transformer capable of automatic input power adjustment for charging a battery during the operation of an electronic apparatus, the transformer comprising:
a switch module for transmitting external power or interrupting input of the external power;
a power supply module connected to the switch module for transforming the external power to operation power and transmitting the operation power to the battery; and
a detection module connected to the switch module and the power supply module for requesting the switch module to interrupt input of the external power if the operation power is lower than a charge threshold.

2. The transformer capable of automatic input power adjustment according to claim 1, wherein the detection module is electrically connected to the electronic apparatus.

3. The transformer capable of automatic input power adjustment according to claim 2, wherein the electronic apparatus sends a wake-up command to the detection module for requiring the detection module to request the switch module to transmit the external power.

4. The transformer capable of automatic input power adjustment according to claim 1, wherein the switch module is electrically connected to the electronic apparatus.

5. The transformer capable of automatic input power adjustment according to claim 4, wherein the electronic apparatus sends a wake-up command to the switch module for requiring the switch module to transmit the external power.

6. The transformer capable of automatic input power adjustment according to claim 1, wherein the electronic apparatus is a personal computer, a notebook, a tablet, or a cellphone.

7. A computer capable of automatic input power adjustment, comprising:
an electronic apparatus, comprising a power source module and a wake-up module; and
a transformer, comprising a switch module, a power supply module and a detection module, the power supply module being connected to the switch module and the detection module; the switch module transmitting external power to the power supply module; the power supply module transforming the external power to operation power and transmitting the operation power to the power source module; and when the operation power is lower than a charge threshold, the detection module requesting the switch module to stop receiving the external power.

8. The computer capable of automatic input power adjustment according to claim 7, wherein the wake-up module is connected to the detection module, and the wake-up module sends a wake-up command for requiring the detection module to request the switch module to transmit the external power.

9. The computer capable of automatic input power adjustment according to claim 7, wherein the wake-up module is connected to the switch module, and the wake-up module sends a wake-up command for requiring the switch module to receive the external power.
